(19) United States
(12) Patent Application Publication
(10) Pub. No.: US 2025/0375062 A1
(43) Pub. Date: Dec. 11, 2025

(54) FLYWHEEL ROTISSERIE

(71) Applicant: Dan Bowling, Nicholasville, KY (US)

(72) Inventor: Dan Bowling, Nicholasville, KY (US)

(21) Appl. No.: 19/218,914

(22) Filed: May 27, 2025

Related U.S. Application Data
(60) Provisional application No. 63/656,123, filed on Jun. 5, 2024.

(51) Int. Cl. A47J 37/04; A23L 5/10; A47J 33/00

(52) U.S. Cl. CPC A47J 37/043; A23L 5/10; A47J 33/00

(57) ABSTRACT

A cooking device including a pan and a pan support coupled to the pan. The pan support is configured to be supported by a cord. The pan support is configured to support the pan adjacent to the heat source. The pan acts as a flywheel that uses kinetic energy to intermittently rotate the pan in a first direction and a second direction so food placed on the pan rotates relative to the heat source thereby evenly heating the food.

### CROSS REFERENCE TO RELATED APPLICATION

This application claims the priority of U.S. Provisional Patent Application Ser. No. 63/656,123, filed on Jun. 5, 2024 (pending), the disclosure of which is incorporated herein by reference in its entirety.

### TECHNICAL FIELD

The present application relates to a non-motorized rotisserie device for the roasting of food adjacent to a heat source.

### BACKGROUND

The 2021 North American Camping Report states active camper households in the US increased by a record 3.9 million from 86.1 million reported in 2020. As part of the camping experience, cooking over an open fire is popular and evokes feelings of nostalgia among a large number of people. Having a non-motorized way of roasting on a rotisserie without the need of constant effort and attention provided by the user is a welcome advantage in cookery, such as in a primitive setting whether it be an outdoor campfire, inside at a fireplace hearth, or a Chiminea as some examples. String roasting is an ancient method of cooking meat before an open fire and is heard very little about today.

### SUMMARY

Generally, a cooking device is provided. The cooking device includes a pan and a pan support coupled to the pan. The pan support is configured to be supported by a cord. The pan support is configured to support the pan adjacent to a heat source. The pan acts as a flywheel that uses kinetic energy to intermittently rotate the pan in a first direction and a second direction so food placed on the pan rotates relative to the heat source thereby evenly heating the food.

In some embodiments, the cooking device may include the cord for supporting the pan adjacent to a heat source. The cooking device may include a pan support coupled to the pan and configured to support the pan. The pan support may be removably coupled to the pan. The pan may include a pan support hole. The pan support may be inserted through the pan support hole thereby coupling the pan to the pan support. At least a portion of the pan support hole may be tapered. At least a portion of the pan support may be tapered. The pan support may include a hanging hook configured to be coupled to a cord for supporting the cooking device. The pan support may include a skewer configured to couple the pan to the hanging hook. The pan may include a pan outer edge and a raised edge along at least a portion of the pan outer edge. The pan may include at least one of a pour spout or a handle. The pan may include a pan outer edge and the mass of the pan may be biased toward the pan outer edge.

An alternative cooking device is provided. The cooking device includes a pan, a hanging hook configured to be supported by a cord and a skewer configured to couple the pan to the hanging hook. The hanging hook is configured to support the pan adjacent to a heat source. The pan acts as a flywheel that uses kinetic energy to intermittently rotate the pan in a first direction and a second direction so food placed on the pan rotates relative to the heat source thereby evenly heating the food.

In some embodiments, the cooking device may include the cord for supporting the pan adjacent to a heat source. The skewer may be removably coupled to the pan. The pan may include a pan support hole. The skewer may be inserted through the pan support hole thereby coupling the pan to the skewer. At least a portion of the pan support hole may be tapered. At least a portion of the skewer may be tapered. The pan may include a pan outer edge and a raised edge along at least a portion of the pan outer edge. The pan may include at least one of a pour spout or a handle. The pan may include an outer edge and the mass of the pan may be biased toward the pan outer edge.

An alternative cooking device is provided. The cooking device including a pan, a hanging hook, a cord, and a skewer. The hanging hook configured to support the pan adjacent to the heat source. The cord is configured to support the hanging hook. The skewer is removably coupled to the pan and configured to couple the pan to the hanging hook. The pan acts as a flywheel that uses kinetic energy to intermittently rotate the pan in a first direction and a second direction so food placed on the pan rotates relative to the heat source thereby evenly heating the food.

In some embodiments, the cooking device may include the cord for supporting the pan adjacent to a heat source. The skewer may be removably coupled to the pan. The pan may include a pan support hole. The skewer may be inserted through the pan support hole thereby coupling the pan to the skewer. At least a portion of the pan support hole may be tapered. At least a portion of the skewer may be tapered. The pan may include a pan outer edge and a raised edge along at least a portion of the pan outer edge. The pan may include at least one of a pour spout or a handle. The pan may include an outer edge and the mass of the pan may be biased toward the pan outer edge.

A method of using a cooking device is provided. The method of using the cooking device includes suspending a pan adjacent to a heat source by a cord, placing food on the pan, rotating the pan in a first direction, and allowing the pan to act as a flywheel using kinetic energy to intermittently rotate in the first direction and a second direction so the food rotates relative to the heat source thereby evenly heating the food.

In some embodiments, the method may include coupling a skewer to the pan, coupling a hanging hook to the cord, and coupling the skewer to the hanging hook.

### BRIEF DESCRIPTION OF DRAWINGS

FIG. 1 is a perspective view of an illustrative flywheel rotisserie being used to roast meat and vegetables near a heat source.

FIG. 2 is a perspective view of the flywheel rotisserie of FIG. 1 showing a pan of the flywheel rotisserie in cross-section.

FIG. 3 is a partial section view of the flywheel rotisserie of FIG. 1.

FIG. 4 is a perspective view of a pan of the flywheel rotisserie of FIG. 1.

FIG. 5 is a section view of the pan of FIG. 4.

FIG. 6 is an elevation view of a skewer of the flywheel rotisserie of FIG. 1.

FIG. 7 is an elevation view of a hanging hook of the flywheel rotisserie of FIG. 1.

FIG. 8 shows the flywheel rotisserie of FIG. 1 disassembled for storage or transport.

### DETAILED DESCRIPTION

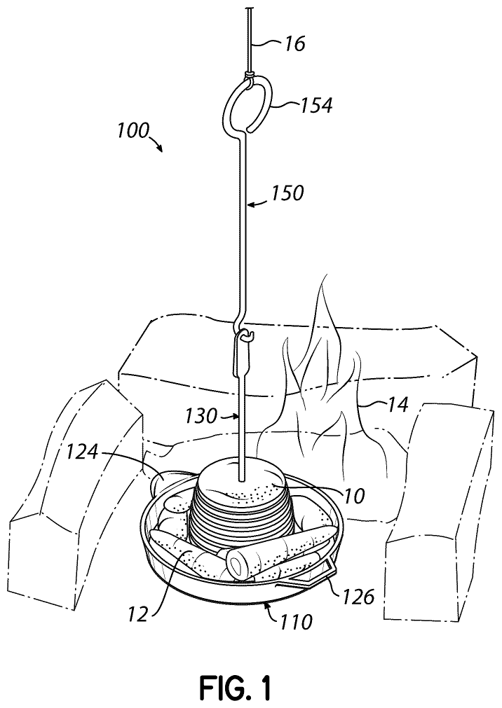

FIG. 1 is a perspective view of a flywheel rotisserie 100 which is configured to support and rotate food 10, 12 adjacent to a heat source 14 to evenly heat the food 10, 12. The flywheel rotisserie 100 is supported by a cord 16 or cable, such as a loop of butcher's twine, to a point above and off center of the heat source 14. The flywheel rotisserie 100 includes a pan 110, a skewer 130, and a hanging hook 150. The flywheel rotisserie 100 may also include the cord 16, or the cord 16 may be supplied separately, such as by a user of the flywheel rotisserie 100. The pan 110 includes a cooking surface or base 112 with a raised outer rim 114. The raised outer rim 114 allows the pan 110 to serve as a drip tray to collect renderings, such as juices rendered from roasting meat 10, which may be used for basting and making sauces, for example. The pan 110 may also be used for roasting vegetables 12 or other foods while the main entrée, such as meat 10 for example, is cooking. In some embodiments, the rim 114 includes a molded pour spout 124 and a handle 126 oriented on the opposite side of the rim 114 to facilitate pouring liquids from the pan 110 while suspended from the skewer 130. The pan 110 includes a conical hub 116 which is generally positioned at the center of the pan 110. The hub 116 has a conical hole 118 or bore which is larger at the bottom 120 of the hub 116 and smaller at the top 122 of the hub 116. In this illustrative embodiment, the hub 116 and the hole 118 are generally round. In other embodiments, the size and shape of the hub 116 and/or the hole 118 may vary so long as the hub 116 and hole 118 support and stabilize the pan 110 while in use as described herein.

In this illustrative embodiment, the pan 110 is constructed of cast iron. The pan 110 may be manufactured from any food safe material having the strength, heat tolerance, and mass necessary to function as a flywheel in an environment hot enough to roast meat, for example. The pan 110 may be manufactured from any ferrous or nonferrous metals, metal alloys, ceramics, or glass-ceramics suitable for cooking.

The rim 114 helps bias the weight of the pan 110 toward the outer portion of the pan 110 helping the pan 110 to function as a rimed or weighted flywheel as described herein. In this illustrative embodiment, the base 112 of the pan 110 is 9″ to 14″ in diameter and approximately 3/16″ thick. The rim 114 is approximately ½″ thick and 1″ high and is canted outward approximately 20 degrees from vertical. The ratio of pan diameter to rim height may be 4:1 to 20:1. The pan has an approximate weight of 4 to 5 pounds.

The thicker rim 114 of the pan 110 allows the mass of the pan 110 to be distributed away from the center of the pan 110. This mass distribution maximizes the storage of rotational kinetic energy allowing the pan 110 to act as a flywheel. The pan 110 dimensions may be scaled up or down as long as the mass and diameter of the pan 110 enable the pan 110 to function as a flywheel. Increasing the diameter of the pan 110 moves the mass farther from the central of the pan 110, but it does so at the expense of moving what is being cooked farther from the heat. Increasing the height of the raised rim 114 at the perimeter the pan 110 may add weight to the perimeter of the flywheel at the expense of creating a heat shield to what is being roasted.

The skewer 130 has a conical lower end portion 132 which is larger at the bottom 134 of the lower end portion 132 and smaller at the top 136 of the lower end portion 132. The profile of the lower end portion 132 of the skewer 130 is the same as the profile of the hole 118 of the pan 110 allowing the lower end portion 132 of the skewer 130 to be accepted securely into the hub 116. In this illustrative embodiment, the lower end portion 132 of the skewer 130 and the hole 118 of the pan 110 are generally round. In other embodiments, the size and shape of the lower end portion 132 and/or the hole 118 may vary so long as the skewer 130 supports and stabilizes the pan 110 while in use as described herein. When inserted through hole 118 of the pan 110, the skewer 130 is generally perpendicular to a plane defined by the pan 110. When inserted through the pan 110, the skewer 130 will remain stable and fixed when the pan 110 is set on a flat surface. The conical attachment of the skewer 130 to the pan 110 allows for toolless disassembly for cleaning and storage. The conical attachment of the skewer 130 to the pan 110 also allows for simplicity in the manufacturing process of joining the skewer 130 and the pan 110 together. In this illustrative embodiment, the lower end portion 132 of the skewer 130 and hole 118 of the pan 110 are generally round. In other embodiments, the size and shape of the lower end portion 132 and/or the hole 118 may vary so long as the skewer 130 supports and stabilizes the pan 110 while in use as described herein.

The skewer 130 includes an upper end portion 138 formed into a sharpened blade 140 with a hole 142 configured to accept the hanging hook 150. The skewer 130 defines a vertical axis 144 around which the flywheel rotisserie 100 rotates when in use. In this illustrative embodiment, the skewer 130, is approximately 12″ long and is fabricated from mild steel, but could be made from any food safe metal or metal alloy. The skewer 130 also aids in the transfer of heat into the center of the food during roasting as does the heating of the pan 110 adjacent to the heat source.

The hanging hook 150 is formed from a metal rod and includes a hook 152 at the lower end portion of the hanging hook 150 and a ring 154 at the upper end portion of the hanging hook 150 connected by a shaft 156. The hook 152 is configured to be accepted into the hole 142 in the skewer 130. Together the skewer 130 and the hanging hook 150 form a pan support 160. In this illustrative embodiment, the hanging hook 150 is approximately 12″ long and the ring 154 is approximately 3″ in diameter. In this illustrative embodiment, the ring 154 is spaced away from the heat source 14 which keeps the ring 154 cooler so the user can easily add energy into the system, by turning the ring 154, without burning his/her fingers. Additionally, spacing the ring 154 from the heat source 14 protects the cord 16. The ring 154 at the top is large enough to easily grasp for lifting as well as allowing a user to apply torque easily with one hand. In this illustrative embodiment, the ring 154 and the shaft 156 of the hanging hook 150 are within a first plane, while the hook 152 defines a second plane perpendicular to the first plane.

A user will suspend the flywheel rotisserie 100 by connecting a cord 16 or cable, such as a loop of butcher's twine, to a point above and off center of the heat source and to the ring 154 of the hanging hook 150. The pan 110 and skewer 130 assembly is suspended from the hook 152 of the hanging hook 150. The user will rotate the flywheel rotisserie 100 and the flywheel rotisserie 100 will continue to rotate unassisted to cook the food 10, 12.

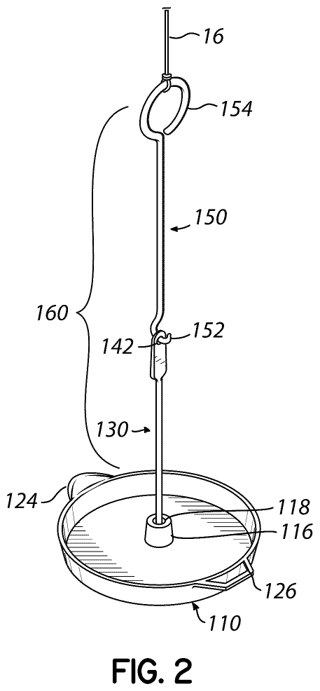

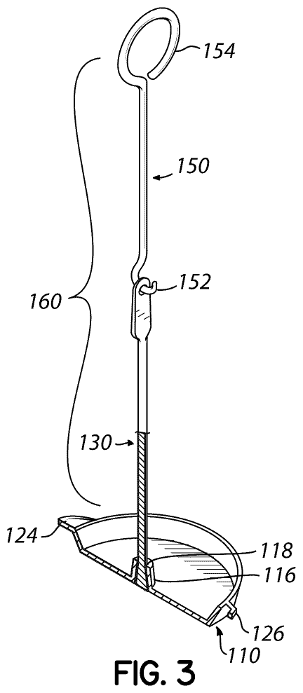

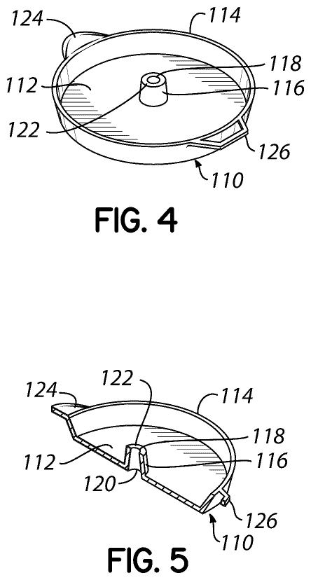

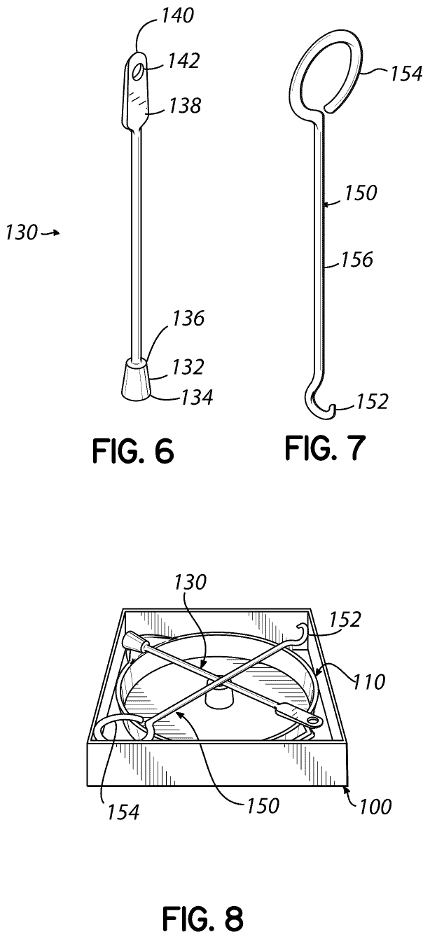

The lengths of the skewer 130 and the hanging hook 150 may be approximately equal. A hanging hook 150 the same length as the skewer 130 may allow the skewer 130 to be shorter making the skewer 130 easier to load, store, and clean. Although lengths for the skewer 130 and hanging hook 150 can be variable, a 12″ length for both the skewer 130 and hanging hook 150 may be optimal for breakdown and storage, as shown in FIG. 2, as well as keeping the top end of the hanging hook 150 cool enough to handle without gloves and overall ease of use.

The flywheel rotisserie 100 can be easily broken down and stored flat with only about an inch and a half in stacked height. The removable skewer 130 is safer than a fixed skewer, for example, because the only time the skewer 130 would be attached to the pan 110 would be when it is being loaded or unloaded on a tabletop or when it is in use (hanging from the hanging hook 150). The skewer 130 will fall out of the pan 110 if the pan 110 is not supported by a flat surface or if the pan 110 is raised without supporting the skewer 130, such as when the skewer 130 is suspended by the hanging hook 150.

In this illustrative embodiment, the upper end of the hanging hook 150 is formed into a 3″ diameter ring 154 through which a cord 16, such as a length of cotton butcher's twine for example is passed. The two free ends of the cord 16 are tied together allowing the loop of cord 16 formed when tying the knot to be hooked over or coupled to whatever fixed point is being used to suspend the device from above and off center of the source of heat. This allows the full weight of the pan 110, the skewer 130, and the hanging hook 150, plus whatever is being cooked, to suspend from the fixed stationary point which supports the flywheel rotisserie 100 by the cord 16, all of which spin freely with minimal friction to impede rotation. The length of the cord 16 can be adjusted so whatever is roasting on the vertically oriented skewer 130 is rotating as low and as close beside the heat source as possible without the pan 110 hitting anything that would prevent the pan 110 from rotating freely. Generally, the pan 110 is oriented adjacent to the heat source, such as a wood fire, and not directly above the heat source.

The flywheel rotisserie 100 works on the principle that the weighted pan 110 with raised rim 114 and hub 116 in the center form a flywheel which rotates around the vertical axis formed by the cord 16, hanging hook 150, and skewer 130. The flywheel rotisserie 100 stores the rotational kinetic energy initiated by the user (cook) who sets the flywheel rotisserie 100 in motion. As the pan 110 rotates, the two sides of the loop of cord 16 wind around each other, thereby shortening the vertical length of the loop, until the force of the kinetic energy initiated by the cook equals the resistance of the wound-up cord 16 and the subsequent lifting of the flywheel rotisserie 100. At the point rotation eases to a stop and the weight of the flywheel rotisserie 100 coupled with the torque of the twisted cord 16 start the flywheel rotisserie 100 rotating in the opposite direction building up rotational energy to carry the flywheel rotisserie 100 past the midpoint and wind the cord 16 in the opposite direction until the force of the rotational energy against the wound cord 16 and lifting of the flywheel rotisserie 100 again reach equilibrium, then the process repeats, rotating back and forth until the cook has to add more energy into the system by adding torque via the 3″ circular upper end of the hanging hook 150 hanging from the loop of cord 16. The subsequent winding of the loop of cord 16 and lifting of the weighted pan 110, pairs with the use of a flywheel to form a torsional pendulum which significantly increases the time of rotation lessening input from the user to keep the flywheel rotisserie 100 rotating to expose the food being cooked to the heat evenly on all sides as the food rotates before the heat source.

The non-motorized flywheel rotisserie 100 is powered by minimal input from the user and utilizing a weighted flywheel to store rotational kinetic energy along with torsional pendulum principles to prolong rotation, the need for electricity is eliminated along with the need for constant attention and effort by the user significantly freeing up the user for the accomplishment of other tasks.

Additional aspects and advantages of the invention will become more apparent upon further review of the detailed description of the illustrative embodiments taken in conjunction with the accompanying drawings.

While the present invention has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A cooking device comprising:
a pan; and
a pan support coupled to the pan, the pan support is configured to be supported by a cord, and the pan support is configured to support the pan adjacent to a heat source;
wherein the pan acts as a flywheel that uses kinetic energy to intermittently rotate the pan in a first direction and a second direction so food placed on the pan rotates relative to the heat source thereby evenly heating the food.

2. The cooking device of claim 1, further comprising the cord.

3. The cooking device of claim 3, wherein the pan support is removably coupled to the pan.

4. The cooking device of claim 3, wherein the pan further comprises a pan support hole, and
wherein the pan support is inserted through the pan support hole thereby coupling the pan to the pan support.

5. The cooking device of claim 4, wherein at least a portion of the pan support hole is tapered, and
wherein at least a portion of the pan support is tapered.

6. The cooking device of claim 1, wherein the pan support comprises:
a hanging hook configured to be coupled to a cord for supporting the cooking device; and
a skewer configured to couple the pan to the hanging hook.

7. The cooking device of claim 1, wherein the pan comprises:
a pan outer edge; and
a raised edge along at least a portion of the pan outer edge.

8. The cooking device of claim 1, wherein the pan comprises at least one of a pour spout or a handle.

9. The cooking device of claim 1, wherein the pan comprises a pan outer edge;
wherein the pan has a mass and the mass of the pan is biased toward the pan outer edge.

10. A cooking device comprising:
a pan;
a hanging hook configured to be supported by a cord, and the hanging hook is configured to support the pan adjacent to a heat source; and
a skewer configured to couple the pan to the hanging hook;
wherein the pan acts as a flywheel that uses kinetic energy to intermittently rotate the pan in a first direction and a second direction so food placed on the pan rotates relative to the heat source thereby evenly heating the food.

11. The cooking device of claim 10, further comprising the cord.

12. The cooking device of claim 10, wherein the skewer is removably coupled to the pan.

13. The cooking device of claim 12, wherein the pan further comprises a pan support hole, and
wherein the skewer is inserted through the pan support hole thereby coupling the pan to the skewer.

14. The cooking device of claim 13, wherein at least a portion of the pan support hole is tapered, and
wherein at least a portion of the skewer is tapered.

15. The cooking device of claim 10, wherein the pan comprises:
a pan outer edge; and
a raised edge along at least a portion of the pan outer edge.

16. The cooking device of claim 10, wherein the pan comprises at least one of a pour spout or a handle.

17. The cooking device of claim 10, wherein the pan comprises a pan outer edge;
wherein the pan has a mass and the mass of the pan is biased toward the pan outer edge.

18. A cooking device comprising:
a pan;
a hanging hook configured to support the pan adjacent to the heat source;
a cord configured to support the hanging hook;
a skewer removably coupled to the pan and configured to couple the pan to the hanging hook;
wherein the pan acts as a flywheel that uses kinetic energy to intermittently rotate the pan in a first direction and a second direction so food placed on the pan rotates relative to the heat source thereby evenly heating the food.

19. The cooking device of claim 18, wherein the pan further comprises a pan support hole, and
wherein the skewer is inserted through the pan support hole thereby coupling the pan to the skewer.

20. The cooking device of claim 19, wherein at least a portion of the pan support hole is tapered, and
wherein at least a portion of the skewer is tapered.

21. The cooking device of claim 18, wherein the pan comprises:
a pan outer edge; and
a raised edge along at least a portion of the pan outer edge.

22. The cooking device of claim 18, wherein the pan comprises at least one of a pour spout or a handle.

23. The cooking device of claim 18, wherein the pan comprises a pan outer edge;
wherein the pan has a mass and the mass of the pan is biased toward the pan outer edge.

24. A method of using a cooking device, the method comprising:
suspending a pan adjacent to a heat source by a cord;
placing food on the pan;
rotating the pan in a first direction;
allowing the pan to act as a flywheel using kinetic energy to intermittently rotate in the first direction and a second direction so the food rotates relative to the heat source thereby evenly heating the food.

25. The method of claim 24, further comprising:
coupling a skewer to the pan;
coupling a hanging hook to the cord; and
coupling the skewer to the hanging hook.
